(19) United States
(12) Patent Application Publication
(10) Pub. No.: US 2024/0125677 A1
(43) Pub. Date: Apr. 18, 2024

(54) METHOD AND SYSTEM FOR DETECTING MICROPLASTICS WITH SMALL PARTICLE SIZE, ELECTRONIC DEVICE AND MEDIUM

(71) Applicant: CHINA INSTITUTE OF WATER RESOURCES AND HYDROPOWER RESEARCH, Beijing (CN)

(72) Inventors: BO GAO, Beijing (CN); DONGYU XU, Beijing (CN); MINGLU MA, Beijing (CN)

(21) Appl. No.: 18/155,572

(22) Filed: Jan. 17, 2023

(30) Foreign Application Priority Data
Oct. 13, 2022 (CN) 202211253993.4

(51) Int. Cl. G01N 1/28; G01N 21/65; G01N 21/84

(52) U.S. Cl. CPC G01N 1/28; G01N 21/65; G01N 21/84; G01N 2001/4088

(57) ABSTRACT

Disclosed is to a method and system for detecting microplastics with a small particle size, an electronic device and a medium. The method includes: magnifying the filter membrane mosaic of the to-be-preliminarily-screened microplastics sample by multiple magnifications to obtain multiple magnified filter membrane mosaics; identifying each of the magnified filter membrane mosaics by a particle identification tool to obtain a magnified filter membrane mosaic with a highest identification rate; identifying the magnified filter membrane mosaic with a highest identification rate under the condition of multiple groups of identification parameter combinations to obtain a preliminarily screened parameter set; identifying each of the microplastics samples under the condition of each identification parameter combination in the preliminarily screened parameter set to obtain an identification rate and an identification accuracy of the microplastics sample under each identification parameter combination; obtaining an optimal identification parameter combination.

### CROSS REFERENCE TO RELATED APPLICATION

This patent application claims the benefit and priority of Chinese Patent Application No. 202211253993.4, filed with the China National Intellectual Property Administration on Oct. 13, 2022, the disclosure of which is incorporated by reference herein in its entirety as part of the present application.

### TECHNICAL FIELD

The present disclosure relates to the technical field of microplastics detection, and in particular to a method and system for detecting microplastics with a small particle size, an electronic device and a medium.

### BACKGROUND

At present, there are mainly two microplastics detection methods. The first method is to manually select suspected microplastics particles, and then identify chemical components by infrared spectroscopy, Raman spectroscopy, and thermal analysis. etc. The second method is to detect suspected microplastics by in-situ testing. Micro-Fourier Transform Infrared (micro-FTIR) spectroscopy and micro-Raman spectroscopy is currently most widely used.

For the first method, an operator should be skilled to pick out the suspect-microplastics. However, due to the limitations of human operation, only larger particles can be selected, which leads to low selection efficiency. The second method is to place a pre-treated filter membrane under a device to directly identify the chemical component, which greatly solves the defects of the first method. In addition, due to limited spatial resolution of micro-FTIR spectroscopy, only particles larger than 10 m can only be identified. By contrast, micro-Raman spectroscopy has low spatial resolution and can identify microplastics with the particle size down to 1 μm, hence becoming a powerful tool for detecting microplastics with a small particle size (≥1 m).

At present, two commonly used methods in micro-Raman are to acquire spectra through point-by-point detection and to select a certain area for spectrum acquisition. These two methods both have the defect of high time-consuming, and therefore hard to detect the microplastics in large quantities of samples. An existing method of particle identification based on automatic particle selection is adopted to reduce the time-consuming during the process of detection. However, improper detection parameters may lead to several problems. For example, the areas outside the filter membrane may be superfluously detected, as well as the detected microplastics spectrum is poorly matched with the standard spectrum libraries, ultimately resulting in the low detection accuracy of microplastics with the small particle size.

### SUMMARY

An objective of the present disclosure is to provide a method and system for detecting microplastics with a small particle size, an electronic device and a medium.

To achieve the above objective, the present disclosure provides the following technical solutions:

The present disclosure provides a method for detecting microplastics with a small particle size, the method including:
acquiring a microplastics sample set, where the microplastics sample set includes different types of microplastics samples, and one microplastics sample corresponds to each of the different types;
selecting any of the microplastics samples from the microplastics sample set as a to-be-preliminarily-screened microplastics sample, and placing the to-be-preliminarily-screened microplastics sample into a micro-Raman sample pool to obtain a filter membrane mosaic of the to-be-preliminarily-screened microplastics sample;
magnifying the filter membrane mosaic of the to-be-preliminarily-screened microplastics sample by multiple magnifications to obtain multiple magnified filter membrane mosaics;
identifying each of the magnified filter membrane mosaics by a particle identification tool to obtain a magnified filter membrane mosaic with a highest identification rate;
identifying, by the particle identification tool, the magnified filter membrane mosaic with a highest identification rate based on multiple groups of identification parameter combinations to obtain a preliminarily screened parameter set, where the preliminarily screened parameter set includes an identification parameter combination with an identification rate greater than a preset threshold value; each of the multiple groups of identification parameter combinations includes a preset number of exposure time and a preset number of scan times; and the multiple groups of identification parameter combinations differ in the preset numbers;
identifying any of microplastics samples in a remaining microplastics sample set based on the identification parameter combinations in the preliminarily screened parameter set to obtain identification rates and identification accuracies of the microplastics sample under the identification parameter combinations in the preliminarily screened parameter set; where the remaining microplastics sample set includes remaining microplastics samples after the to-be-preliminarily-screened microplastics sample is removed from the microplastics sample set;
obtaining an optimal identification parameter combination according to the identification rate and the identification accuracy of each of the microplastics samples in the remaining microplastics sample set under each identification parameter combination in the preliminarily screened parameter set; and
identifying a filter membrane to be detected under the optimal identification parameter combination to obtain a component, a size and an amount of microplastics in the filter membrane to be detected.

Optionally, said identifying a filter membrane to be detected under the optimal identification parameter combination to obtain a component, a size and an amount of microplastics in the filter membrane to be detected, specifically includes:
putting the filter membrane to be detected in the micro-Raman sample pool to obtain a filter membrane mosaic of the filter membrane to be detected;
magnifying the filter membrane mosaic of the filter membrane to be detected by an optimal magnification to obtain a magnified filter membrane mosaic of the filter membrane to be detected; where the optimal magnification corresponds to the magnified filter membrane mosaic with a highest identification rate; and
identifying the magnified filter membrane mosaic of the filter membrane to be detected by the particle identification tool under the optimal identification parameter combination to obtain the component, the size and the amount of the microplastics in the filter membrane to be detected.

Optionally, said identifying the magnified filter membrane mosaic of the filter membrane to be detected by the particle identification tool under the optimal identification parameter combination to obtain the component, the size and the amount of the microplastics in the filter membrane to be detected specifically includes:
magnifying the magnified filter membrane mosaic of the filter membrane to be detected to obtain a filter membrane mosaic to be processed;
processing the filter membrane mosaic to be processed by automatic particle selection in the particle identification tool, and selecting all particles to be processed in the filter membrane mosaic to be processed;
acquiring, based on the optimal identification parameter combination, and according to a multi-point acquisition mode, all the particles to be processed in the filter membrane mosaic to be processed; and
obtaining, according to the spectra of the particles to be processed, components, sizes and a total quantity of all the particles to be processed.

The present disclosure further provides a system for detecting microplastics with a small particle size, the system including:
a sample acquisition module configured to acquire a microplastics sample set, where the microplastics sample set includes different types of microplastics samples, and one microplastics sample corresponds to each of the different types;
a microplastics sample processing module configured to select any of the microplastics samples from the microplastics sample set as a to-be-preliminarily-screened microplastics sample, and place the to-be-preliminarily-screened microplastics sample into a micro-Raman sample pool to obtain a filter membrane mosaic of the to-be-preliminarily-screened microplastics sample;
a magnifying module configured to magnify the filter membrane mosaic of the to-be-preliminarily-screened microplastics sample by multiple magnifications to obtain multiple magnified filter membrane mosaics;
a first identification module configured to identify each of the magnified filter membrane mosaics by a particle identification tool to obtain a magnified filter membrane mosaic with a highest identification rate;
a preliminary screening module configured to identify, by the particle identification tool, the magnified filter membrane mosaic with a highest identification rate based on multiple groups of identification parameter combinations to obtain a preliminarily screened parameter set, where the preliminarily screened parameter set includes an identification parameter combination with an identification rate greater than a preset threshold value; each of the multiple groups of identification parameter combinations includes a preset number of exposure time and a preset number of scan times; and the multiple groups of identification parameter combinations differ in the preset numbers;
a second identification module configured to identify any of microplastics samples in a remaining microplastics sample set based on the identification parameter combinations in the preliminarily screened parameter set to obtain identification rates and identification accuracies of the microplastics sample under the identification parameter combinations in the preliminarily screened parameter set; where the remaining microplastics sample set includes remaining microplastics samples after the to-be-preliminarily-screened microplastics sample is removed from the microplastics sample set;
an optimal identification parameter combination determining module configured to obtain an optimal identification parameter combination according to the identification rate and the identification accuracy of each of the microplastics samples in the remaining microplastics sample set under each identification parameter combination in the preliminarily screened parameter set; and
a microplastics detection module configured to identify a filter membrane to be detected under the optimal identification parameter combination to obtain a component, a size and an amount of microplastics in the filter membrane to be detected.

Optionally, the microplastics detection module specifically includes:
a mosaic unit configured to obtain a filter membrane mosaic of the filter membrane to be detected by enabling a mosaic function after placing the filter membrane to be detected in the micro-Raman sample pool;
a magnifying unit configured to magnify the filter membrane mosaic of the filter membrane to be detected by an optimal magnification to obtain a magnified filter membrane mosaic of the filter membrane to be detected; where the optimal magnification corresponds to the magnified filter membrane mosaic with a highest identification rate; and
a detection unit configured to identify the magnified filter membrane mosaic of the filter membrane to be detected by the particle identification tool under the optimal identification parameter combination to obtain the component, the size and the amount of the microplastics in the filter membrane to be detected.

Optionally, the detection unit specifically includes:
a magnifying subunit configured to magnify the magnified filter membrane mosaic of the filter membrane to be detected to obtain a filter membrane mosaic to be processed;
automatic particle selection subunit configured to process the filter membrane mosaic to be processed by automatic particle selection in the particle identification tool, and select all particles to be processed in the filter membrane mosaic to be processed;
a spectrum determining subunit configured to acquire, based on the optimal identification parameter combination, and according to a multi-point acquisition mode, spectra of all the particles to be processed in the filter membrane mosaic to be processed; and
a detection subunit configured to obtain, according to the spectra of the particles to be processed, components, sizes and a total quantity of all the particles to be processed.

The present disclosure further provides an electronic device, including:
a memory and a processor, where the memory is configured to store a computer program, and the processor runs the computer program to enable the electronic device to execute the foregoing method for detecting microplastics with a small particle size.

The present disclosure further provides a computer-readable storage medium, where the computer-readable storage medium stores a computer program, and the computer program is executed by a processor to implement the foregoing method for detecting microplastics with a small particle size.

According to specific embodiments of the present disclosure, the present disclosure has the following technical effects: a preliminarily screened parameter set is obtained according to a polystyrene (PS) microplastics sample; an optimal identification parameter combination is obtained by screening the preliminarily screened parameter set according to a polypropylene (PP) microplastics sample and a polyethylene terephthalate (PET) microplastics sample, and microplastics with a small particle size are identified according to the optimal identification parameter combination, which can improve the identification accuracy of the microplastics with a small particle size.

### BRIEF DESCRIPTION OF THE DRAWINGS

To describe the embodiments of the present disclosure or the technical solutions in the related art more clearly, the accompanying drawings required in the embodiments are briefly introduced below. Obviously, the accompanying drawings described below are only some embodiments of the present disclosure. A person of ordinary skill in the art may further obtain other accompanying drawings based on these accompanying drawings without creative labor.

FIG. 1 is a flowchart of a method for detecting microplastics with a small particle size according to an embodiment of the present disclosure;

FIG. 2 illustrates influence of magnifications on accuracy of particle identification;

FIG. 3 illustrates comparison before and after typical defects in particle identification are processed using automatic particle selection method according to an embodiment of the present disclosure; and

FIG. 4 is a schematic diagram showing typical defects existing in a detection result.

### DETAILED DESCRIPTION OF THE EMBODIMENTS

The technical solutions of the embodiments of the present disclosure are clearly and completely described below with reference to the accompanying drawings. Apparently, the described embodiments are merely a part rather than all of the embodiments of the present disclosure. All other embodiments obtained by those of ordinary skill in the art based on the embodiments of the present disclosure without creative efforts shall fall within the protection scope of the present disclosure.

To make the above-mentioned objective, features, and advantages of the present disclosure clearer and more comprehensible, the present disclosure will be further described in detail below in conjunction with the accompanying drawings and specific embodiments.

An embodiment of the present disclosure provides a method for detecting microplastics with a small particle size, the method including:

Acquire a microplastics sample set, where the microplastics sample set includes different types of microplastics samples, and one microplastics sample corresponds to each of the different types.

Select any of the microplastics samples from the microplastics sample set as a to-be-preliminarily-screened microplastics sample, and place the to-be-preliminarily-screened microplastics sample into a micro-Raman sample pool to obtain a filter membrane mosaic of the to-be-preliminarily-screened microplastics sample.

Magnify the filter membrane mosaic of the to-be-preliminarily-screened microplastics sample by multiple magnifications to obtain multiple magnified filter membrane mosaics.
identify each of the magnified filter membrane mosaics by a particle identification tool to obtain a magnified filter membrane mosaic with a highest identification rate.

Identify, by the particle identification tool, the magnified filter membrane mosaic with a highest identification rate based on multiple groups of identification parameter combinations to obtain a preliminarily screened parameter set, where the preliminarily screened parameter set includes an identification parameter combination with an identification rate greater than a preset threshold value; each of the multiple groups of identification parameter combinations includes a preset number of exposure time and a preset number of scan times; and the multiple groups of identification parameter combinations differ in the preset numbers.
identify any of microplastics samples in a remaining microplastics sample set based on the identification parameter combinations in the preliminarily screened parameter set to obtain identification rates and identification accuracies of the microplastics sample under the identification parameter combinations in the preliminarily screened parameter set; where the remaining microplastics sample set includes remaining microplastics samples after the to-be-preliminarily-screened microplastics sample is removed from the microplastics sample set.

Obtain an optimal identification parameter combination according to the identification rate and the identification accuracy of each of the microplastics samples in the remaining microplastics sample set under each identification parameter combination in the preliminarily screened parameter set.
identify a filter membrane to be detected under the optimal identification parameter combination to obtain a component, a size and an amount of microplastics in the filter membrane to be detected.

In practical applications, said identify a filter membrane to be detected under the optimal identification parameter combination to obtain a component, a size and an amount of microplastics in the filter membrane to be detected specifically includes:

Place the filter membrane to be detected in the micro-Raman sample pool to obtain a filter membrane mosaic of the filter membrane to be detected.

Magnify the filter membrane mosaic of the filter membrane to be detected by an optimal magnification to obtain a magnified filter membrane mosaic of the filter membrane to be detected; where the optimal magnification corresponds to the magnified filter membrane mosaic with a highest identification rate.
identify the magnified filter membrane mosaic of the filter membrane to be detected by the particle identification tool under the optimal identification parameter combination to obtain the component, the size and the amount of the microplastics in the filter membrane to be detected.

In practical application, said identify the magnified filter membrane mosaic of the filter membrane to be detected by the particle identification tool under the optimal identification parameter combination to obtain the component, the size and the amount of the microplastics in the filter membrane to be detected specifically includes:

Magnify the magnified filter membrane mosaic of the filter membrane to be detected to obtain a filter membrane mosaic to be processed.

Process the filter membrane mosaic to be processed by automatic particle selection in the particle identification tool, and select all particles to be processed in the filter membrane mosaic to be processed.

Acquire, based on the optimal identification parameter combination, and according to a multi-point acquisition mode, all the particles to be processed in the filter membrane mosaic to be processed.

Obtain, according to the spectra of the particles to be processed, components, sizes and a total quantity of all the particles to be processed.

An embodiment of the present disclosure further provides a system for detecting microplastics with a small particle size corresponding to the foregoing method, the system including:
a sample acquisition module configured to acquire a microplastics sample set, where the microplastics sample set includes different types of microplastics samples, and one microplastics sample corresponds to each of the different types;
a microplastics sample processing module configured to select any of the microplastics samples from the microplastics sample set as a to-be-preliminarily-screened microplastics sample, and place the to-be-preliminarily-screened microplastics sample into a micro-Raman sample pool to obtain a filter membrane mosaic of the to-be-preliminarily-screened microplastics sample;
a magnifying module configured to magnify the filter membrane mosaic of the to-be-preliminarily-screened microplastics sample by multiple magnifications to obtain multiple magnified filter membrane mosaics;
a first identification module configured to identify each of the magnified filter membrane mosaics by a particle identification tool to obtain a magnified filter membrane mosaic with a highest identification rate;
a preliminary screening module configured to identify, by the particle identification tool, the magnified filter membrane mosaic with a highest identification rate based on multiple groups of identification parameter combinations to obtain a preliminarily screened parameter set, where the preliminarily screened parameter set includes an identification parameter combination with an identification rate greater than a preset threshold value; each of the multiple groups of identification parameter combinations includes a preset number of exposure time and a preset number of scan times; and the multiple groups of identification parameter combinations differ in the preset numbers;
a second identification module configured to identify any of microplastics samples in a remaining microplastics sample set based on the identification parameter combinations in the preliminarily screened parameter set to obtain identification rates and identification accuracies of the microplastics sample under the identification parameter combinations in the preliminarily screened parameter set; where the remaining microplastics sample set includes remaining microplastics samples after the to-be-preliminarily-screened microplastics sample is removed from the microplastics sample set;
an optimal identification parameter combination determining module configured to obtain an optimal identification parameter combination according to the identification rate and the identification accuracy of each of the microplastics samples in the remaining microplastics sample set under each identification parameter combination in the preliminarily screened parameter set; and
a microplastics detection module configured to identify a filter membrane to be detected under the optimal identification parameter combination to obtain a component, a size and an amount of microplastics in the filter membrane to be detected.

In practical application, the microplastics detection module specifically includes:
a mosaic unit configured to obtain a filter membrane mosaic of the filter membrane to be detected by enabling a mosaic function after placing the filter membrane to be detected in the micro-Raman sample pool;
a magnifying unit configured to magnify the filter membrane mosaic of the filter membrane to be detected by an optimal magnification to obtain a magnified filter membrane mosaic of the filter membrane to be detected; where the optimal magnification corresponds to the magnified filter membrane mosaic with a highest identification rate; and
a detection unit configured to identify the magnified filter membrane mosaic of the filter membrane to be detected by the particle identification tool under the optimal identification parameter combination to obtain the component, the size and the amount of the microplastics in the filter membrane to be detected.

In practical application, the detection unit specifically includes:
a magnifying subunit configured to magnify the magnified filter membrane mosaic of the filter membrane to be detected to obtain a filter membrane mosaic to be processed;
automatic particle selection subunit configured to process the filter membrane mosaic to be processed by automatic particle selection in the particle identification tool, and select all particles to be processed in the filter membrane mosaic to be processed;
a spectrum determining subunit configured to acquire, based on the optimal identification parameter combination, and according to a multi-point acquisition mode, spectra of all the particles to be processed in the filter membrane mosaic to be processed; and
a detection subunit configured to obtain, according to the spectra of the particles to be processed, components, sizes and a total quantity of all the particles to be processed.

An embodiment of the present disclosure further provides an electronic device, including:
a memory and a processor, where the memory is configured to store a computer program, and the processor runs the computer program to enable the electronic device to execute the foregoing method for detecting microplastics with a small particle size.

An embodiment of the present disclosure further provides a computer-readable storage medium, where the computer-readable storage medium stores a computer program, and the computer program is executed by a processor to implement the foregoing method for detecting microplastics with a small particle size.

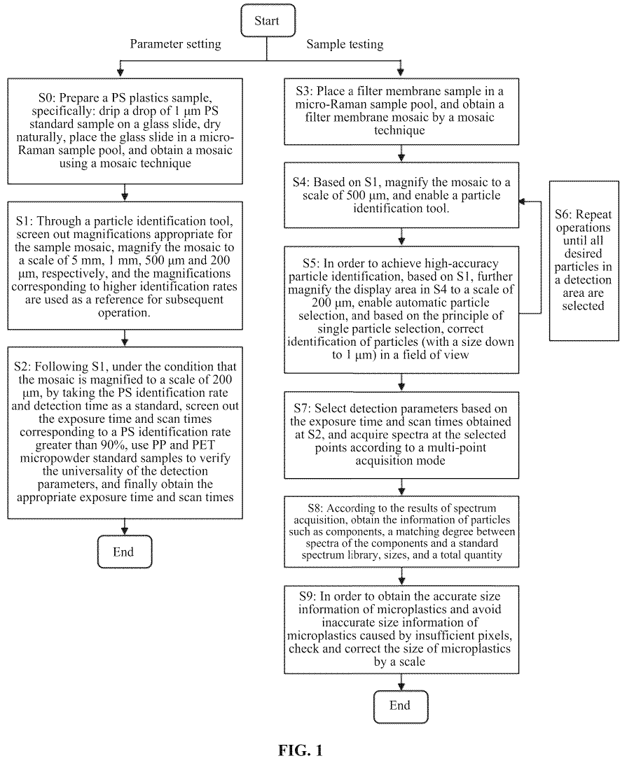

The present disclosure also provides a more specific method for detecting microplastics with a small particle size, as shown in FIG. 1. The detailed steps are as follows:

The experimental procedure mainly includes two parts, namely parameter screening and sample testing. In the part of parameter screening, PS, PP and PET microplastics standard substances are used for detection, and in the part of sample testing, particles released from masks are used for detection.

Firstly, the part of parameter setting includes:

S0: Prepare a PS plastics sample, specifically: drip a drop of 1 μm PS standard sample on a glass slide, dry naturally, place the glass slide in a micro-Raman sample pool, and obtain a mosaic using a mosaic technique.

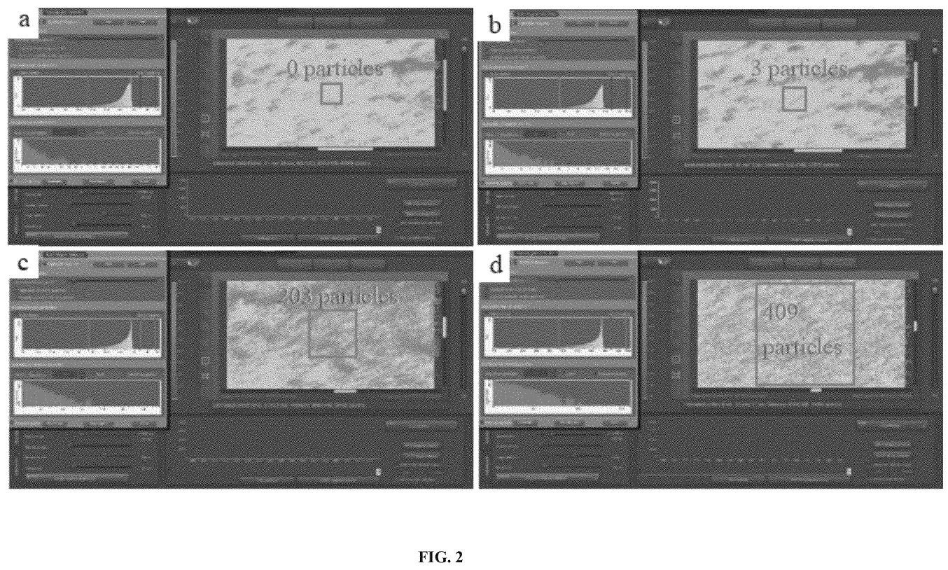

S1: Through a particle identification tool, screen out magnifications appropriate for the sample mosaic, magnify the mosaic to a scale of 5 mm, 1 mm, 500 m and 200 m, respectively, and the magnifications corresponding to higher identification rates are used as a reference for subsequent operation. The results of accuracy of particle identification under different magnifications in the same frame selection area are shown in FIG. 2, where the frame selection area has a size of 1 mm×1 mm.

S2: Following S1, under the condition that the mosaic is magnified to a scale of 200 min, obtain a PS identification number and actual detection time by adjusting the exposure time and scan times of micro-Raman detection, and obtain a PS identification rate according to a ratio of the PS identification number to a total quantity of identification particles. The detection results are shown in Table 1:

TABLE 1
Effects of exposure time and scan times on the identification
rate and detection time of PS microplastics

| | Scan | | Scanning | PS | Actual |
|---|---|---|---|---|---|
| | times/ | Exposure | results | identification | detection |
| SN | scans | time/sec | PS/particles | rate/% | time |
| 1 | 10 | 0.0100 | 25/50 | 50 | 10 min 07 s |
| 2 | 10 | 0.0400 | 41/50 | 82 | 13 min 44 s |
| 3 | 10 | 0.1000 | 47/50 | 94 | 16 min 20 s |
| 4 | 20 | 0.0100 | 31/50 | 62 | 12 min 43 s |
| 5 | 20 | 0.0400 | 47/50 | 94 | 17 min 17 s |
| 6 | 20 | 0.0625 | 45/50 | 90 | 22 min 01 s |
| 7 | 20 | 0.0833 | 48/50 | 96 | 23 min 38 s |
| 8 | 20 | 0.1000 | 49/50 | 98 | 23 min 50 s |

Note:
laser power: 7.0 mW; image pixel: 1 μm.

Furthermore, screen out the exposure time and scan times corresponding to a PS identification rate greater than 90% such that PP and PET micropowder standard samples are detected, and the identification number and the actual detection time of PP and PET are obtained; obtain an identification rate of PP and PET according to a ratio of the identification number of PP and PET to a total quantity of identification particles, and further verify the universality of the detection parameters; furthermore, obtain identification accuracy of PP and PET by identifying the particles that are not identified as PP and PET, and screen out the exposure time and scan times corresponding to the identification rate and accuracy of PP and PET being greater than 90%, so as to finally obtain the appropriate exposure time and scan times. The test results are shown in Table 2 and Table 3:

TABLE 2
Effects of exposure time and scan times on the identification
rate and accuracy of PP microplastics

| | | | Scanning | PP | | |
|---|---|---|---|---|---|---|
| | | Scan | results | identifica- | | Actual |
| | Exposure | times/ | PP/ | tion | Accu- | detection |
| SN | time/sec | scans | particles | rate/% | racy/% | time |
| 1 | 0.1000 | 10 | 48/50 | 96 | 100 | 17 min 15 s |
| 2 | 0.0400 | 20 | 48/50 | 96 | 100 | 16 min 48 s |
| 3 | 0.0833 | 20 | 48/50 | 96 | 100 | 23 min 27 s |
| 4 | 0.1000 | 20 | 48/50 | 96 | 100 | 25 min 41 s |

Note:
laser power: 7.0 mW; image pixel: 1 μm; 1/50 PET/particles; 1/50 Unidentified/particles

TABLE 3
Effects of exposure time and scan times on the identification
rate and accuracy of PET microplastics

| | | | Scanning | PP | | |
|---|---|---|---|---|---|---|
| | | Scan | results | identifica- | | Actual |
| | Exposure | times/ | PP/ | tion | Accu- | detection |
| SN | time/sec | scans | particles | rate/% | racy/% | time |
| 1 | 0.1000 | 10 | 49/50 | 98 | 100 | 18 min 03 s |
| 2 | 0.0400 | 20 | 49/50 | 98 | 100 | 17 min 41 s |
| 3 | 0.0833 | 20 | 49/50 | 98 | 100 | 23 min 38 s |
| 4 | 0.1000 | 20 | 49/50 | 98 | 100 | 25 min 53 s |

Note:
laser power: 7.0 mW; image pixel: 1 μm; 1/50 Unidentified/particles

Next, the part of sample testing includes:

S3: Place a filter membrane sample in a micro-Raman sample pool, and obtain a filter membrane mosaic by a mosaic technique.

S4: Based on S1, magnify the mosaic to a scale of 500 in, and enable a particle identification tool.

S5: In order to achieve high-accuracy particle identification, based on S1, further magnify the display area in S4 to a scale of 200 μm, enable automatic particle selection, and based on the principle of single particle selection, correct identification of particles (with a size down to 1 μm) in a field of view. When some particles are missing or unnecessarily selected due to the difference in background shading between particles or non-particles and filter membrane, carry out the operation of adding or deleting corresponding points; in case the same particle is selected repeatedly, delete the corresponding points, as shown in Table 4.

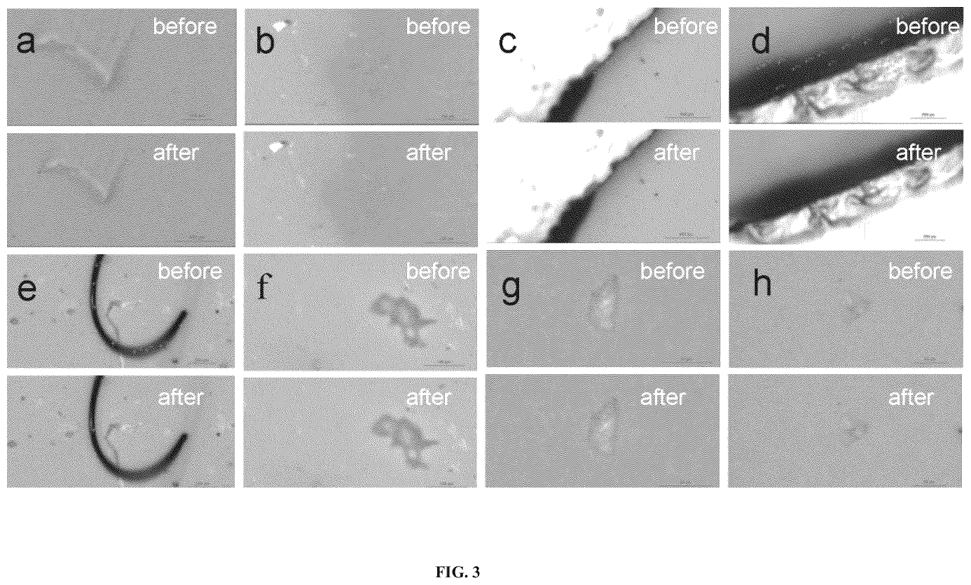

TABLE 4
Typical defects existing in particle identification
and corresponding solution

| | | | Implemen- |
|---|---|---|---|
| SN | Typical defects | Solution | tations |
| 1 | Unidentified particles are | Delete | See FIG. 3A |
| | unnecessarily selected due to the | corresponding | and FIG. 3B |
| | difference in background shading | points according | |
| | between the non-particles and the | to the sequence | |
| | filter membrane | number | |
| 2 | Edges of the filter membrane are | Delete | See FIG. 3C |
| | unnecessarily selected due to the | corresponding | and FIG. 3D |
| | difference in background shading | points according | |
| | between the edges and the filter | to the sequence | |
| | membrane | number | |
| 3 | Irregular particles are identified as | Delete | See FIG. 3E |
| | multiple particles, so they are | corresponding | and FIG. 3F |
| | repeatedly selected many times | points according | |
| | | to the sequence | |
| | | number | |
| 4 | The particles are excluded as they | Select more | See FIG. 3G |
| | have a background shading similar | points that are | and FIG. 3H |
| | to the filter membrane | excluded | |

The four typical defects and solutions mentioned in Table 4 are further illustrated in, e.g., FIG. 3. As shown in FIGS. 3A, 3B, 3C and 3D, selection points for non-particles are canceled after correction, while in FIGS. 3E and 3F, redundant selection points for particles are deleted after correction, so as to ensure single particle selection; in FIGS. 3G and 3H, selection points for particles are added after correction, and single particle selection is ensured.

S6: Repeat operations in S4 and S5 until all desired particles in a detection area are selected.

S7: Select detection parameters based on the exposure time and scan times obtained at S2, and acquire spectra at the selected points according to a multi-point acquisition mode.

S8: According to the results of spectrum acquisition, obtain the information of particles such as components, a matching degree between spectra of the components and a standard spectrum library, sizes, a total quantity, etc.

S9: In order to obtain the accurate size information of microplastics and avoid inaccurate size information of microplastics caused by insufficient pixels, check and correct the size of microplastics by a scale; in case particle size is undervalued or the particle size is missing due to insufficient pixels, measure the length and width of microplastics by the scale. Specific details were shown in Table 5.

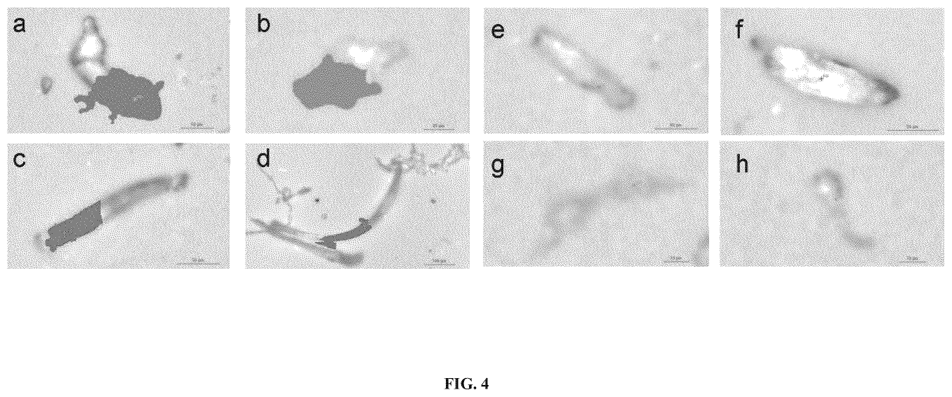

TABLE 5
Typical defects existing in detection
results and corresponding solution

| | | | Implemen- |
|---|---|---|---|
| SN | Typical defects | Solution | tations |
| 1 | Only part of the area of the | Measure the length | See FIG. 4A, |
| | microplastics is identified, | and width of a | FIG. 4B, FIG. |
| | but the size of the | particle using a | 4C and FIG. |
| | microplastics is ignored. | scale | 4D |
| 2 | Information about the size | Measure the length | See FIG. 4E, |
| | of identified microplastics | and width of a | FIG. 4F, FIG. |
| | is missing. | particle using a | 4G and FIG. |
| | | scale | 4H |

The two typical defects mentioned in Table 5 are further illustrated in FIG. 4. In FIG. 4A, FIG. 4B, FIG. 4C and FIG. 4D, the size of microplastics is undervalued due to insufficient pixels. In FIG. 4E, FIG. 4F, FIG. 4G and FIG. 46, the size of microplastics is missing due to insufficient pixels.

The information about the original/corrected size of microplastics in FIG. 4 is shown in Table 6:

TABLE 6
Information about the original/corrected size of particles in FIG. 4

| FIG. | Original/corrected size | Length (μm) | Width (μm) | Material |
|---|---|---|---|---|
| FIG. 4A | Original size | 143.1 | 63.8 | PP |
| FIG. 4A | Corrected size | 182.6 | 35.6 | PP |
| FIG. 4B | Original size | 60 | 28.4 | PP |
| FIG. 4B | Corrected size | 81.6 | 29.4 | PP |
| FIG. 4C | Original size | 84.8 | 28.5 | PET |
| FIG. 4C | Corrected size | 192.6 | 25.0 | PET |
| FIG. 4D | Original size | 129.0 | 36.3 | PET |
| FIG. 4D | Corrected size | 467.7 | 36.3 | PET |
| FIG. 4E | Original size | 0 | 0 | PP |
| FIG. 4E | Corrected size | 55.3 | 13.6 | PP |
| FIG. 4F | Original size | 0 | 0 | PP |
| FIG. 4F | Corrected size | 145.2 | 36.7 | PP |
| FIG. 4G | Original size | 0 | 0 | PP |
| FIG. 4G | Corrected size | 62.3 | 6.8 | PP |
| FIG. 4H | Original size | 0 | 0 | PP |
| FIG. 4H | Corrected size | 34.2 | 4.4 | PP |

The embodiment of the present disclosure establishes a standardized process of particle sample detection, gives reference to key parameter setting for the sample detection process, improves the identification accuracy of microplastics with a small particle size and overcomes the problem that the time cost of microplastics detection is too large, thereby providing ideas for the feasibility of detecting large quantities (˜1,000) of microplastics particles with a particle size down to 1 μm.

Each embodiment of the present specification is described in a progressive manner, each example focuses on the difference from other examples, and the same and similar parts between the examples may refer to each other. Since the system disclosed in an embodiment corresponds to the method disclosed in another embodiment, the description is relatively simple, and reference can be made to the method description.

Specific examples are used herein to explain the principles and embodiments of the present disclosure. The foregoing description of the embodiments is merely intended to help understand the method of the present disclosure and its core ideas; besides, various modifications may be made by a person of ordinary skill in the art to specific embodiments and the scope of application in accordance with the ideas of the present disclosure. In conclusion, the content of the present specification shall not be construed as limitations to the present disclosure.

1. A method for detecting microplastics with a small particle size, comprising:
acquiring a microplastics sample set, wherein the microplastics sample set comprises different types of microplastics samples, and one microplastics sample corresponds to each of the different types;
selecting any of the microplastics samples from the microplastics sample set as a to-be-preliminarily-screened microplastics sample, and placing the to-be-preliminarily-screened microplastics sample into a micro-Raman sample pool to obtain a filter membrane mosaic of the to-be-preliminarily-screened microplastics sample;
magnifying the filter membrane mosaic of the to-be-preliminarily-screened microplastics sample by multiple magnifications to obtain multiple magnified filter membrane mosaics;
identifying each of the magnified filter membrane mosaics by a particle identification tool to obtain a magnified filter membrane mosaic with a highest identification rate;
identifying, by the particle identification tool, the magnified filter membrane mosaic with a highest identification rate based on multiple groups of identification parameter combinations to obtain a preliminarily screened parameter set, wherein the preliminarily screened parameter set comprises an identification parameter combination with an identification rate greater than a preset threshold value; each of the multiple groups of identification parameter combinations comprises a preset number of exposure time and a preset number of scan times; and the multiple groups of identification parameter combinations differ in the preset numbers;
identifying any of microplastics samples in a remaining microplastics sample set based on the identification parameter combinations in the preliminarily screened parameter set to obtain identification rates and identification accuracies of the microplastics sample under the identification parameter combinations in the preliminarily screened parameter set; wherein the remaining microplastics sample set comprises remaining microplastics samples after the to-be-preliminarily-screened microplastics sample is removed from the microplastics sample set;
obtaining an optimal identification parameter combination according to the identification rate and the identification accuracy of each of the microplastics samples in the remaining microplastics sample set under the identification parameter combinations in the preliminarily screened parameter set; and
identifying a filter membrane to be detected under the optimal identification parameter combination to obtain a component, a size and an amount of microplastics in the filter membrane to be detected.

2. The method for detecting microplastics with a small particle size according to claim 1, wherein said identifying a filter membrane to be detected under the optimal identification parameter combination to obtain a component, a size and an amount of microplastics in the filter membrane to be detected specifically comprises:
putting the filter membrane to be detected in the micro-Raman sample pool to obtain a filter membrane mosaic of the filter membrane to be detected;
magnifying the filter membrane mosaic of the filter membrane to be detected by an optimal magnification to obtain a magnified filter membrane mosaic of the filter membrane to be detected; wherein the optimal magnification corresponds to the magnified filter membrane mosaic with a highest identification rate; and
identifying the magnified filter membrane mosaic of the filter membrane to be detected by the particle identification tool under the optimal identification parameter combination to obtain the component, the size and the amount of the microplastics in the filter membrane to be detected.

3. The method for detecting microplastics with a small particle size according to claim 2, wherein said identifying the magnified filter membrane mosaic of the filter membrane to be detected by the particle identification tool under the optimal identification parameter combination to obtain the component, the size and the amount of the microplastics in the filter membrane to be detected specifically comprises:
magnifying the magnified filter membrane mosaic of the filter membrane to be detected to obtain a filter membrane mosaic to be processed;
processing the filter membrane mosaic to be processed by automatic particle selection in the particle identification tool, and selecting all particles to be processed in the filter membrane mosaic to be processed;
acquiring, based on the optimal identification parameter combination, and according to a multi-point acquisition mode, all the particles to be processed in the filter membrane mosaic to be processed; and
obtaining, according to the spectra of the particles to be processed, components, sizes and a total quantity of all the particles to be processed.

4. A system for detecting microplastics with a small particle size, comprising:
a sample acquisition module configured to acquire a microplastics sample set, wherein the microplastics sample set comprises different types of microplastics samples, and one microplastics sample corresponds to each of the different types;
a microplastics sample processing module configured to select any of the microplastics samples from the microplastics sample set as a to-be-preliminarily-screened microplastics sample, and place the to-be-preliminarily-screened microplastics sample into a micro-Raman sample pool to obtain a filter membrane mosaic of the to-be-preliminarily-screened microplastics sample;
a magnifying module configured to magnify the filter membrane mosaic of the to-be-preliminarily-screened microplastics sample by multiple magnifications to obtain multiple magnified filter membrane mosaics;
a first identification module configured to identify each of the magnified filter membrane mosaics by a particle identification tool to obtain a magnified filter membrane mosaic with a highest identification rate;
a preliminary screening module configured to identify, by the particle identification tool, the magnified filter membrane mosaic with a highest identification rate based on multiple groups of identification parameter combinations to obtain a preliminarily screened parameter set, wherein the preliminarily screened parameter set comprises an identification parameter combination with an identification rate greater than a preset threshold value; each of the multiple groups of identification parameter combinations comprises a preset number of exposure time and a preset number of scan times; and the multiple groups of identification parameter combinations differ in the preset numbers;
a second identification module configured to identify any of microplastics samples in a remaining microplastics sample set based on the identification parameter combinations in the preliminarily screened parameter set to obtain identification rates and identification accuracies of the microplastics sample under the identification parameter combinations in the preliminarily screened parameter set; wherein the remaining microplastics sample set comprises remaining microplastics samples after the to-be-preliminarily-screened microplastics sample is removed from the microplastics sample set;
an optimal identification parameter combination determining module configured to obtain an optimal identification parameter combination according to the identification rate and the identification accuracy of each of the microplastics samples in the remaining microplastics sample set under each identification parameter combination in the preliminarily screened parameter set; and
a microplastics detection module configured to identify a filter membrane to be detected under the optimal identification parameter combination to obtain a component, a size and an amount of microplastics in the filter membrane to be detected.

5. The system for detecting microplastics with a small particle size according to claim 4, wherein the microplastics detection module specifically comprises:
a mosaic unit configured to obtain a filter membrane mosaic of the filter membrane to be detected by enabling a mosaic function after placing the filter membrane to be detected in the micro-Raman sample pool;
a magnifying unit configured to magnify the filter membrane mosaic of the filter membrane to be detected by an optimal magnification to obtain a magnified filter membrane mosaic of the filter membrane to be detected; wherein the optimal magnification corresponds to the magnified filter membrane mosaic with a highest identification rate; and
a detection unit configured to identify the magnified filter membrane mosaic of the filter membrane to be detected by the particle identification tool under the optimal identification parameter combination to obtain the component, the size and the amount of the microplastics in the filter membrane to be detected.

6. The system for detecting microplastics with a small particle size according to claim 5, wherein the detection unit specifically comprises:
a magnifying subunit configured to magnify the magnified filter membrane mosaic of the filter membrane to be detected to obtain a filter membrane mosaic to be processed;
automatic particle selection subunit configured to process the filter membrane mosaic to be processed by automatic particle selection in the particle identification tool, and select all particles to be processed in the filter membrane mosaic to be processed;
a spectrum determining subunit configured to acquire, based on the optimal identification parameter combination, and according to a multi-point acquisition mode, spectra of all the particles to be processed in the filter membrane mosaic to be processed; and
a detection subunit configured to obtain, according to the spectra of the particles to be processed, components, sizes and a total quantity of all the particles to be processed.

7. An electronic device, comprising:
a memory and a processor, wherein the memory is configured to store a computer program, and the processor runs the computer program to enable the electronic device to execute the method for detecting microplastics with a small particle size according to claim 1.

8. (canceled)

9. The electronic device according to claim 7, wherein said identifying a filter membrane to be detected under the optimal identification parameter combination to obtain a component, a size and an amount of microplastics in the filter membrane to be detected specifically comprises:
putting the filter membrane to be detected in the micro-Raman sample pool to obtain a filter membrane mosaic of the filter membrane to be detected;
magnifying the filter membrane mosaic of the filter membrane to be detected by an optimal magnification to obtain a magnified filter membrane mosaic of the filter membrane to be detected; wherein the optimal magnification corresponds to the magnified filter membrane mosaic with a highest identification rate; and
identifying the magnified filter membrane mosaic of the filter membrane to be detected by the particle identification tool under the optimal identification parameter combination to obtain the component, the size and the amount of the microplastics in the filter membrane to be detected.

10. The electronic device according to claim 9, wherein said identifying the magnified filter membrane mosaic of the filter membrane to be detected by the particle identification tool under the optimal identification parameter combination to obtain the component, the size and the amount of the microplastics in the filter membrane to be detected specifically comprises:
magnifying the magnified filter membrane mosaic of the filter membrane to be detected to obtain a filter membrane mosaic to be processed;
processing the filter membrane mosaic to be processed by automatic particle selection in the particle identification tool, and selecting all particles to be processed in the filter membrane mosaic to be processed;
acquiring, based on the optimal identification parameter combination, and according to a multi-point acquisition mode, all the particles to be processed in the filter membrane mosaic to be processed; and
obtaining, according to the spectra of the particles to be processed, components, sizes and a total quantity of all the particles to be processed.
